(19) United States
(12) Patent Application Publication
(10) Pub. No.: US 2004/0068873 A1
(43) Pub. Date: Apr. 15, 2004

(54) Rotary trimmer and shaving device

(76) Inventor: Thomas Tona, Nesconset, NY (US)

Correspondence Address: WILLIAM COLLARD, COLLARD & ROE, P.C., 1077 NORTHERN BOULEVARD, ROSLYN, NY, 11576, US

(21) Appl. No.: 10/267,283

(22) Filed: Oct. 9, 2002

(51) Int. Cl. B26B 19/28

(52) U.S. Cl. 30/42; 30/32

(57) ABSTRACT

A shaving device having a handle which houses a motor and a selectively detachable neck. This shaving device also comprises a blade having at least two cutting surfaces with each cutting surface disposed on different planes. The first cutting surface is an elongated cutting surface allowing the user to cut larger areas on the user's skin surface. The second cutting surface is a shorter peripheral cutting surface allowing the user to cut fine sections from the user's face. The neck of the shaving device can have a spring loaded detent that fits inside of a hole on the handle wherein this spring loaded detent snaps inside the hole. The neck can be detached so that different blades or blade housings can be attached to the motor inside of the handle. Thus, with this design this shaving device can be used for different surfaces such as a facial hair trimmer or a nose hair trimmer. The device can be used for different surfaces because there are different type heads and different shaped heads as well.

### BACKGROUND

The invention relates to a shaving device that has a removable neck and head. On the head is a rotatable blade or series of blades wherein these blades can have two different surfaces for cutting.

### SUMMARY

The invention relates to a shaving device that has a housing having a body section and a neck section. The body section houses a motor drive which is an electro-motor which drives a linkage such as a shaft extending through the neck section. At the head of the shaver, is the blade or blades which are housed in a blade housing. The blade is driven in a rotary motion via the rotation of the drive shaft and connecting linkages.

Two unique features of this design is the ability to exchange heads on the shaving device and also the ability to provide two cutting surfaces of the blade or blades. The blades have a sharpened side extending radially out from the axle, and a sharpened peripheral side as well. Thus, a person shaving his or her face or body would be able to cut a larger portion of the face or body with the radial or cutting surface and also have a finely tuned cut for their skin surface with the other peripheral surface.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 shows a side view of the shaving device;

FIG. 2 shows a side view of the shaving device in a detached state;

FIG. 3 shows a perspective view of the shaving device shown in FIG. 1;

FIG. 4 shows a front view of the shaving device of FIG. 1;

FIG. 5 shows a side view of a first embodiment of a blade;

FIG. 6 shows a side view of a second embodiment of the blade;

FIG. 7 shows a side view of a third embodiment of the blade;

FIG. 8 shows a top view of a fourth embodiment of the blades; and

FIG. 9 shows a front view of a second trimming device.

### DETAILED DESCRIPTION

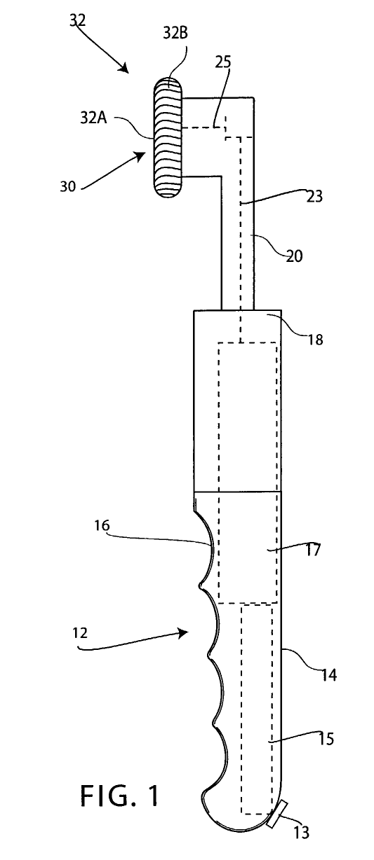

FIG. 1 shows a side view of the shaving device 10 which comprises a handle section 12 having a bottom section 14 with finger grips 16 and a top section 18. Disposed on a bottom section of handle section 12 is a power input port 13. Inside of handle section is a power transformer section 15 which transforms the charge taken from power input into power input port and transports it into useable power for motor 17 disposed inside of handle section 12. Power transformer section 15 can also include a battery so that this device can be used when not plugged into an outlet.

Coupled to handle section 12 is a neck 20, which extends up from handle section 12, and supports a blade 30. One beneficial feature of neck 20 is that it is narrower than handle section 12 and spaces blade 30 away from handle section 12. This narrow neck section creates a clearance area allowing the user to reach hard to reach spaces with the shaver. Neck 20 could be a straight extending neck or an L-shaped neck for spacing said blade away from said handle. In addition, as shown by the dashed lines inside of neck 20, there is a linkage 21 which includes a first shaft and axle combination 23, and a second shaft and axle combination 25. Linkage 21 connects motor 17 to blade 30 so that motor 17 can drive blade 30.

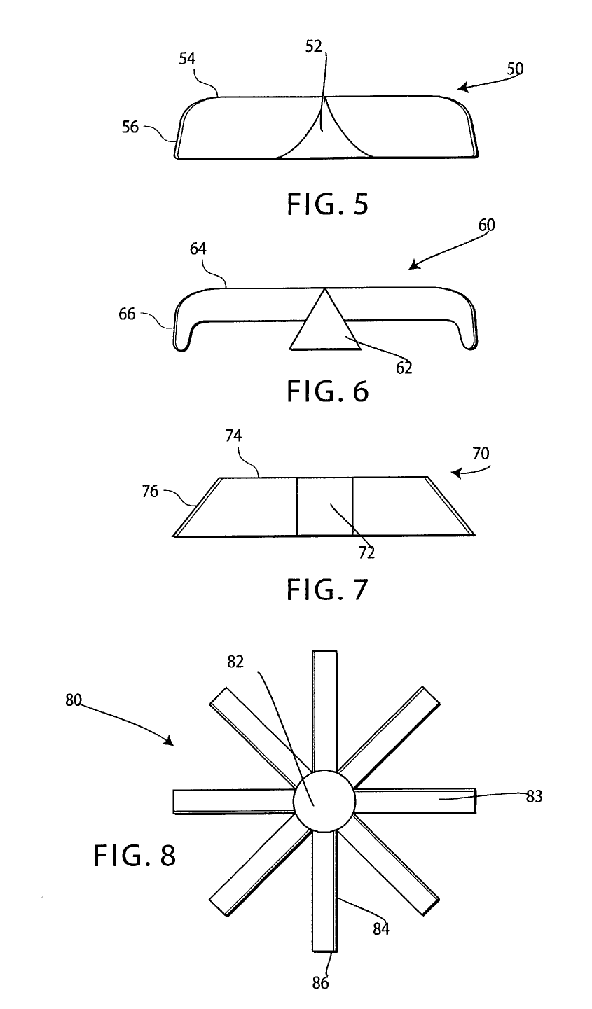

Blade 30 comprises a blade cover 32 having a front face 32A and a side face 32B. Disposed inside of blade cover 32 is a blade which is can be in the form of different blades shown in FIGS. 5-8.

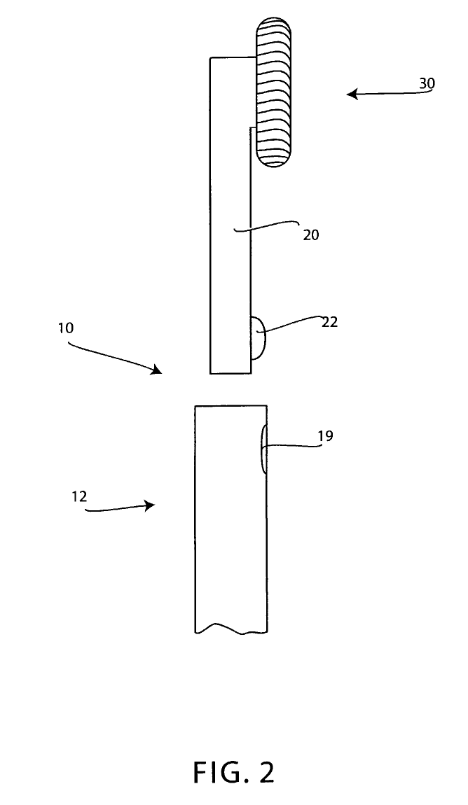

One unique aspect of this shaving device is that the neck can be detached from the handle. As shown in FIG. 2, neck 20 contains a spring loaded detent 22 which can be pressed in and snapped into handle 12. Detent 22 snaps through a hole 19 in handle 12 which then locks detent inside. This locking action keeps neck 20 secured to handle 12.

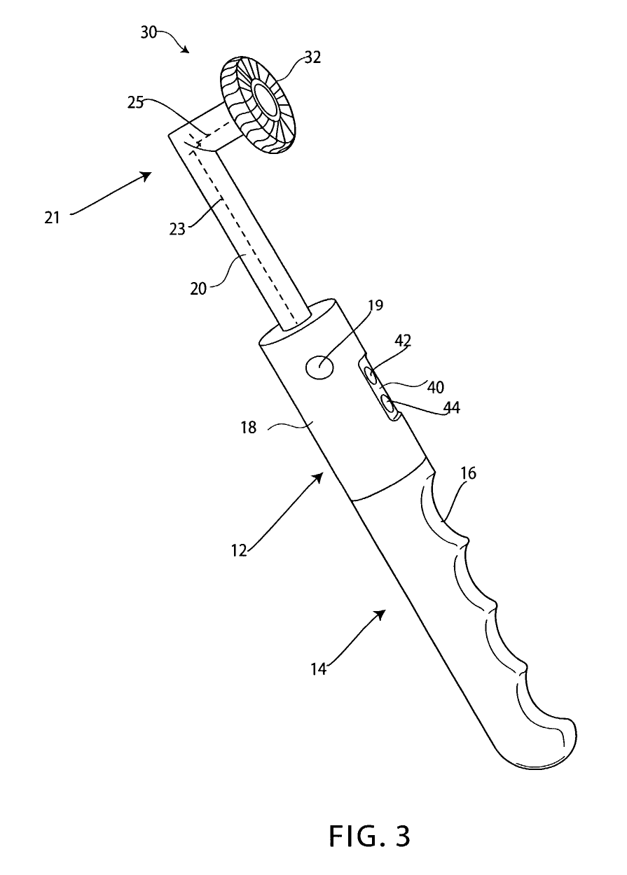

FIG. 3 shows a perspective view of the shaving device wherein there is shown an on/off switch section 40 which contains an on switch 42 and an off switch 44. In addition, as shown in this view, the finger grips 16 are shown recessed to allow a user to wrap his or her fingers around a handle. This rubber coated ergonomic grip allows the user to easily hold the handle while shaving.

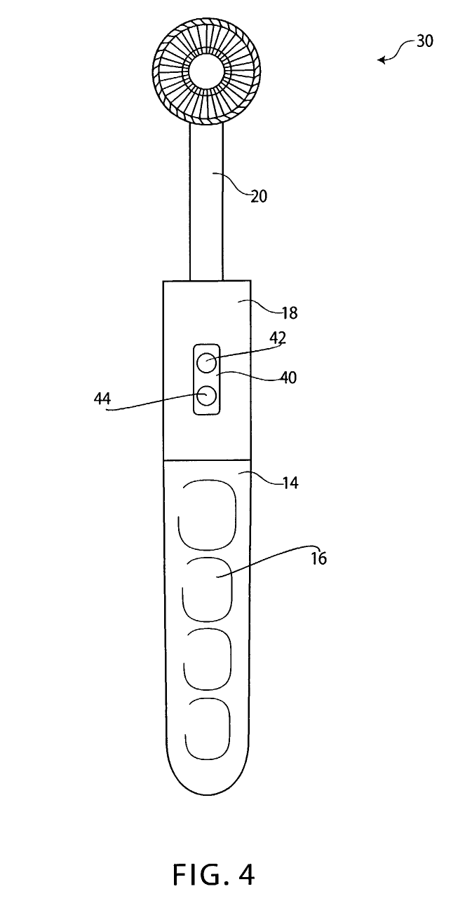

FIG. 4 shows a front view of the handle which shows a front view of shaving surface 32A. In addition, as shown in this view, disposed adjacent to shaving surface 32A is shaving surface 32B which is disposed on a periphery of blade housing 30.

FIG. 5 shows a side view of a first embodiment of the blade, wherein this blade 50 is disposed within blade housing 30 and rotates around a substantially conical shaped axle 52, although an axle of any shape is permissible. This blade is rounded at its corner between two different cutting surfaces. The two cutting surfaces are the cutting face surface 54 and a peripheral cutting surface 56. The cutting face surface 54 extends radially out from the conical shaped axle 52 and provides the largest cutting surface of blade 50. Cutting face surface 54 is used to cut larger areas on a user's skin so that the user can shave relatively large areas of hair off of his or her body at one time.

FIG. 6 shows a side view of a second embodiment of the blade. This second embodiment 60 contains a central axle 62 that is also conically shaped but contains a plurality of substantially L-shaped blades extending radially out from axle 62. These blades contain a cutting face surface 64 and a peripheral cutting surface 66. With this design, the blades contain less material but do not contain any less cutting surface.

FIG. 7 shows a side view of a third embodiment of the blade this third embodiment 70 contains a substantially cylindrical shaped axle 72, from which a plurality of blades radiate out. These blades contain a cutting face surface 74 and a peripheral cutting surface 76. Peripheral cutting surface 76 differs with respect to the other cutting surfaces in that this cutting surface is sloped in towards axle 72 as the blade extends up.

FIG. 8 shows a top view of a fourth embodiment of the blades, however this top view could be similar to a top view of any one of the previously defined blades. With this design, there is a substantially cylindrical axle 82, from which a plurality of blades radiate out. These blades have a cutting face surface 84 and a peripheral cutting surface 86.

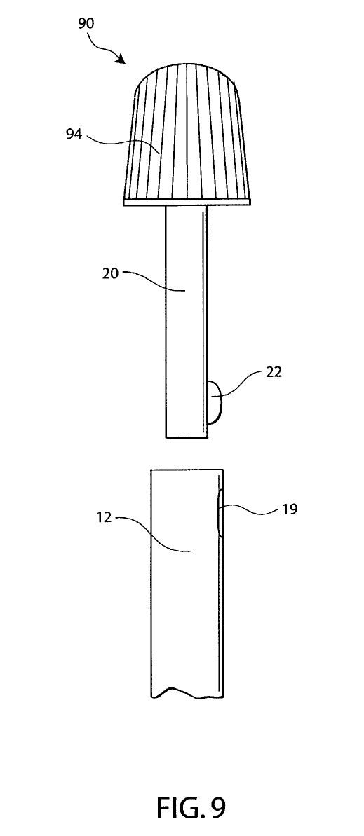

FIG. 9 shows a front view of a second trimming device which can be attached to handle 12 via detent 22. This second trimming device 90 contains a neck 20 and a cylindrical trimming head 94 which differs from the standard trimming head shown in FIGS. 1-4. This second type trimming device can be used essentially as a nose hair trimmer or as a trimmer that can be used to trim hard to reach places.

Accordingly, while at least one embodiment of the present invention has been shown and described, it is to be understood that many changes and modifications may be made thereunto without departing from the spirit and scope of the invention as defined in the appended claims.

What is claimed is:

1. A shaving device comprising:
a) a handle;
b) a motor disposed inside said handle;
c) a detachable neck having a first end detachably coupled to said handle and an opposite distal end; and
d) at least one blade rotatably linked to said neck wherein said at least one blade rotates about an axis.

2. The device as in claim 1, wherein said at least one blade contains at least two cutting surfaces with a first cutting surface formed on a first plane and a second cutting surface formed on said blade on a different plane.

3. The device as in claim 1, wherein said detachable neck contains a spring loaded detent and said handle contains a hole for receiving said spring loaded detent wherein said detent snaps into said hole on said handle when said neck is locked to said handle.

4. The device as in claim 1, wherein said at least one blade has a first cutting surface radiating out from said axis of rotation and a second cutting surface located on a periphery of said blade and substantially perpendicular to said first cutting surface.

5. The device as in claim 4, wherein said at least one blade has a rounded edge between said first cutting surface and said second cutting surface.

6. The device as in claim 1, wherein said at least one blade is substantially L-shaped.

7. The device as in claim 1, further comprising an axle rotatably coupled to said neck wherein said at least one blade is coupled to said at least one axle.

8. The device as in claim 1, wherein said at least one blade comprises a plurality of blade elements extending out from said axis.

9. The device as in claim 1, further comprising a linkage disposed inside said housing and said neck, wherein said at least one blade is driven by said motor via said linkage.

10. The device as in claim 9, wherein said at least one blade rotates substantially perpendicular to a rotation of said motor, and wherein said linkage connects said at least one blade to said motor so that said at least one blade and said motor can rotate on different axes.

11. The device as in claim 1, further comprising a blade housing that is coupled to said neck and covers said at least one blade.

12. The device as in claim 11, wherein said blade housing is substantially wheel shaped.

13. The device as in claim 1, wherein said blade housing is substantially conical shaped.

14. A shaving device comprising:
a) a handle;
b) a motor disposed inside said handle;
c) a neck having a first end coupled to said handle and an opposite distal end; and
d) at least one blade rotatably linked to said neck wherein said at least one blade rotates about an axis and wherein said at least one blade has at least two cutting surfaces wherein each of said cutting surfaces is disposed on a different plane.

15. A shaving device comprising:
a) a handle having at least one hole;
b) a motor disposed inside said handle;
c) a neck having a first end detachably coupled to said handle and an opposite distal end; and
d) a spring loaded detent disposed on said neck, said spring loaded detent for selectively fitting inside said hole on said handle and wherein said neck has a smaller circumference than said handle;
e) at least one blade rotatably linked to said neck wherein said at least one blade rotates about an axis and wherein said at least one blade has at least two cutting surfaces, wherein each of said cutting surfaces is disposed on a different plane; and
f) a blade housing disposed around said at least one blade and coupled to said neck, said blade housing being substantially cylindrical shaped wherein said at least one blade rotates and cuts within said blade housing.
